(19) United States
(12) Patent Application Publication
(10) Pub. No.: US 2024/0327595 A1
(43) Pub. Date: Oct. 3, 2024

(54) METHOD OF MAKING HIGH PEROFRMANCE POLYMER AEROGEL ABSORBENT FOR WATER RETENTION IN SANDY SOIL

(71) Applicant: Alfaisal University, Riyadh (SA)

(72) Inventors: Edreese H Alsharaeh, RIYADH (SA); Haneen Omar, RIYADH (SA)

(73) Assignee: Alfaisal University, RIYADH (SA)

(21) Appl. No.: 18/129,984

(22) Filed: Apr. 3, 2023

(51) Int. Cl. C08J 9/28; C08J 9/00; C09K 17/22

(52) U.S. Cl. CPC C08J 9/28; C08J 9/0023; C08J 9/0028; C08J 9/0066; C09K 17/22; C08J 2201/0504; C08J 2205/026; C08J 2333/26

(57) ABSTRACT

The method of making polyacrylamide (PAM) aerogel are described. Different ratios of PAM in the construction of aerogels were tested. The material was tested for water retention after drying. freeze-dried aerogel samples especially PAM 15 wt %, have a higher swelling ratio with a faster water absorption rate compared to gel and oven-dried samples.

### FILED OF INVENTION

This application describes method of making a polymer aerogel to enhance water retention in sandy soil.

### BACKGROUND

Many countries with arid land suffer from desertification due to the low water storage capacity of sand with extremely high water evaporation and lack of rain. Hence, the food insecurity is an ever standing challenge. Despite the water affinity towards the sand, the main limitation remains to be the water retention by the sand. With world population on the rise and climate change there is an urgent need to increase food production in every possible area. There is an urgent need for a sustainable solution that is easy to implement.

### SUMMARY OF INVENTION

The current invention describes a method of making a polymer aerogel added to the soil to retain water. This invention presents a novel super absorbent hydrogel/aerogel (SAH) with high swelling ratio (SR) along with high water retention ratio (WRR), using different ratios of PAM hydrogel for agriculture applications. In one embodiment, this invention discloses a super-absorbent hydrogels/aerogel (SAHs) based on polyacrylamide (PAM) polymer with a three-dimensional network that can absorb and retain a large amount of water under harsh external environments conditions such as heat or pressure, while maintaining their structural integrity. Such hydrogel can be used to improve the water storage capacity of sandy soils and enable agriculture in the desert.

In one embodiment, a method of making a polymer aerogel comprises of mixing a low molecular weight polymer with a deionized water to make a mixture, wherein the low molecular weight polymer is a polyacrylamide, wherein the polyacrylamide is used in different ratios at 15%, 30% and 75%; stirring the mixture to dissolve at room temperature to make a solution; adding a known amount of hydroquinone, hexamethylenetetramine and KCl salt to the solution to make a mixed solution; placing the mixed solution in a hydrothermal vessel inside an oven for 8 hours and 150° C. to make the polymer aerogel; immersing the polymer aerogel containing 15% ratio of a polyacrylamide in water to measure a water absorption, swelling ratio, water retention and recyclability; and using the polymer aerogel to irrigate agricultural land.

In one embodiment, the polymer aerogel can be oven-dried or freeze-dried. In another embodiment, wherein the swelling ratio was calculated using equation 1. In one embodiment, the water retention ratio was calculated using equation 2. In one instance the best swelling ratio was found in polymer aerogel containing 15% polyacrylamide in polymer aerogel was observed

Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1 shows the proposed addition of PAM aerogel to the soil.

FIG. 2 shows the effect of drying of the PAM aerogel and once introduced to moisture how it swells up.

FIG. 3 shows the preparation of PAM aerogels with different PAM ratios at different drying methods.

FIG. 4 shows FTIR spectra of the PAM aerogels with different Pam ratio with all characteristics peaks.

FIG. 5 shows the distinctive peaks of various components of PAM aerogel.

FIG. 6 shows XRD pattern of PAM aerogels with different PAM ratios.

FIG. 7A and FIG. 7B shows DSC thermograms of PAM aerogel with different PAM ratios.

FIG. 8A and FIG. 8B shows small cut pieces of PAM aerogel in real time and graphical time respectively.

FIG. 9 shows water absorption of PAM aerogel with different PAM ratios.

FIG. 10A shows normal Pam aerogel water absorption, FIG. 10B shows oven dried PAM aerogel water absorption and FIG. 10C shows freeze dried water absorption of PAM aerogel.

FIG. 11A, FIG. 11B and FIG. 11C shows swelling ratio of PAM aerogel between normal, oven dried samples.

FIGS. 12A and 12B shows PAM 15 wt % aerogel before and after being immersed into distilled water to acquire equilibrium swelling at 25° C.

FIG. 13 shows water retention of PAM 115 wt % aerogel with different drying methods in open air at 25° C.

FIG. 14 shows recyclability of PAM 15 wt % aerogels.

FIG. 15A and FIG. 15B shows DSC thermogram of PAM aerogel between normal, oven dried samples.

FIG. 16 shows swelling kinetics behaviour of PAM 15 wt % aerogel.

FIG. 17 shows different swelling kinetics behaviour of PAM 15 wt % aerogel between normal, oven dried samples.

FIG. 18 shows diffusion coefficient value of PAM 15 wt % aerogel.

FIG. 19 shows different diffusion coefficient value of PAM 15 wt % aerogel between normal, oven dried samples.

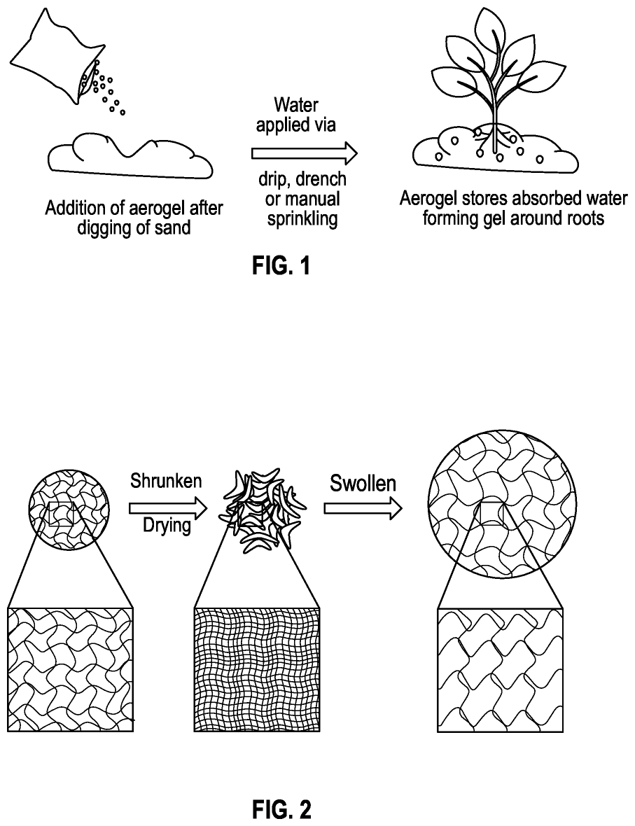

Other features of the present embodiments will be apparent from the accompanying drawings and from the detailed description that follows.

### DETAILED DESCRIPTION

The present disclosure shows a composition, method of making Pam aerogels to retain water for desert agriculture. Globally, the dramatic increase in the worldwide population in recent years raises concerns related to the food security crisis and water scarcity. By 2050, the world population is expected to reach 10 billion people, and their feeding will necessitate an increase in agricultural productivity and water demand. Therefore, future generations need a secure, safe, nutritious, and sustainable food supply. Throughout the specification the term hydrogel and aerogel are used interchangeably but mean the same.

Generally, traditional agricultural production suffers from various limiting factors such as harsh climate, abiotic stresses (temperature, salinity, and drought) and shortage of water resources. Water absorbency and water retention capabilities are the major factors determining the soil's suitability for agricultural production. The plants might be exposed to water deficit, even when rainfall/irrigation is adequate due to the poor water storage capability of the soils. In spite of sandy soils' having high water affinity, water retention remains the primary limitation. Therefore, there is a persistent need to evolve appropriate management practices that lessen water seepage and boost water storage in the soil. The application of soil conditioner become the most popular solution to improve soil structure.

Among various types of soil conditioners, aerogels are the most appealing materials in the agriculture industry. Due to their swelling properties and sustainability release of absorbed molecules acts as a water/molecules reservoir in the root zone. In addition to their low-cost, swollen stability, and highly stimulating soil remediation. Super-absorbent hydrogels (SAHs) are distinct hydrophilic polymers with a three-dimensional network that can absorb and retain a large amount of water even under harsh external environments conditions such as heat or pressure, while maintaining their structural integrity. A wide variety of superabsorbent hydrogels have been used to improve the water storage capacity of sandy soils and enable agriculture in the desert. Nevertheless, the mechanism by which these superabsorbent hydrogels increase plant water availability and seed germination remains unknown. The vast majority of commercial SAHs are synthetic polymers based on polyacrylamide (PAM) and acrylate, which are commercially identified as solid rain (Supare and Mahanwar, 2021) due to their biocompatibility, low toxicity, high stability and super water absorptive properties. PAM is one of the most well-known polymers with noticeable characteristic features, such as high biocompatibility, low toxicity, high stability and super water absorptive properties.

The potential applications of SAHs depend on three main critical parameters, swelling ratio (SR), swelling rate and water retention ratio (WRR). In general, SR value is frequently opposed to WRR. To the best of our knowledge, the most commonly reported SAH have either a high SR or a high WRR. SAH with high SR, in addition to WRR, has been rarely reported. This research aims to design SAH with high SR along with WRR, using different ratios of PAM aerogel for agriculture applications.

Materials and Methods: Low molecular weight polyacrylamide (LMWPAM) (MW=550,000 g/mol) was obtained from the KSA. Hydroquinone (HQ) was purchased from Sigma-Aldrich (UK). Hexamethylenetetramine (HMT) and potassium chloride (KCl) were obtained from Loba Chemie.

Fourier transform infrared (FTIR) spectra were recorded using a Thermo Scientific spectrometer (Nicolet iS10). Powder X-ray diffraction (XRD) measurements were performed using Rigaku MiniFlex 600 using Cu Kα radiation (40 V, 15 mA)=1.54056 Å) in a θ-θ mode from 5° to 90° (2 θ). Differential scanning calorimetry (DSC) measurements were studied using Hitachi DSC7020 from −20° C. to 350° C. at a heating rate of 5° C./min under a nitrogen flow of 50 ml/min.

Preparation of different PAM 15 wt % Aerogel Using In situ Method: 750 mg of low molecular weight PAM was mixed with 5 ml deionized water and stirred for 1 h or until it well dissolve at room temperature. After that, 112.4 mg of hydroquinone (HQ), 112.4 mg of hexamethylenetetramine (HMT) and 375 mg of KCl salt were added to the PAM solution and mixed further for 15 min. The prepared solution was then placed in the hydrothermal vessel in the oven at 150° C. for 8 h. PAM aerogel with ratios of 30 wt %, 50 wt % and 75 wt % were prepared following the same preparation method with varying in PAM, HQ, HMT and KCl weight as shown in Table 1.

TABLE 1
Preparation methods of PAM aerogel with different ratios:

| | | | | PAM solution (5 ml) | | | | |
|---|---|---|---|---|---|---|---|---|
| | | | | PAM | | | KCl | |
| Sample | | Gel | H₂O | 4 wt % | HQ | HMT | 2 wt % | Curing |
| No. | Sample Name | Formation | (ml) | (mg) | (mg) | (mg) | (mg) | Conditions |
| 1 | Low Mol. PAM- | Gel | 5 | 200 | 30 | 30 | 100 | 150° C. and |
| | 4 wt % - (30% | | | | | | | 8 hrs |
| | OrgCL) | | | | | | | |
| 2 | Low Mol. PAM- | Gel | 5 | 750 | 112.4 | 112.4 | 375 | 150° C. and |
| | 15 wt % - (30% | | | | | | | 8 hrs |
| | OrgCL) | | | | | | | |
| 3 | Low Mol. PAM- | Gel | 5 | 1500 | 224.9 | 224.9 | 750 | 150° C. and |
| | 30 wt % - (30% | | | | | | | 8 hrs |
| | OrgCL) | | | | | | | |
| 4 | Low Mol. PAM- | Gel | 5 | 2500 | 374.8 | 374.8 | 1250 | 150° C. and |
| | 50 wt % - (30% | | | | | | | 8 hrs |
| | OrgCL) | | | | | | | |
| 5 | Low Mol. PAM- | Gel | 5 | 3750 | 562.2 | 562.2 | 1875 | 150° C. and |
| | 75 wt % - (30% | | | | | | | 8 hrs |
| | OrgCL) | | | | | | | |

Water Absorption & Water Retention Experiments: To determine the water absorption by different PAM aerogels, some portion of the aerogels was dried in the oven and some in the freeze dryer. The gel form along with the oven-dried and freeze-dried aerogels of known weight were immersed in excess of deionized water. After a predetermined time, the swollen gels were removed from the water and samples were weighed. The water absorption or swelling ratio (SR) (wt %) at different temperatures was calculated using Equation (1).

$$SR \% = \frac{Swollen weight - Dried wieght}{Dried weight} \times 100 \qquad Equation ( 1 )$$

To investigate the effect of the temperature on SR (wt %), the absorption studies were conducted at different temperatures 25, 50 and 80° C. The water retention experiment for PAM aerogel was executed at 25° C. after it reach its' equilibrium swelling by keeping the swollen aerogel sample in the open air for different intervals. The water retention ratio (WRR) was calculated using Equation (2):

$$WRR \% = \frac{Dried wieght}{Swollen weight} \times 100 \qquad Equation ( 2 )$$

Recyclability experiment: The recyclability of the PAM aerogel was investigated by immersing aerogel samples of known weights into an adequate amount of water to reach the equilibrium and the swelling percentage has been determined as per Equation (1). Then, the swollen samples were recovered and dried in the oven until they reach back their original weight. The swelling percentage for the dried aerogel sample was again conducted for the second time similarly. The same procedure was carried out several times to determine the recycling potential of the samples.

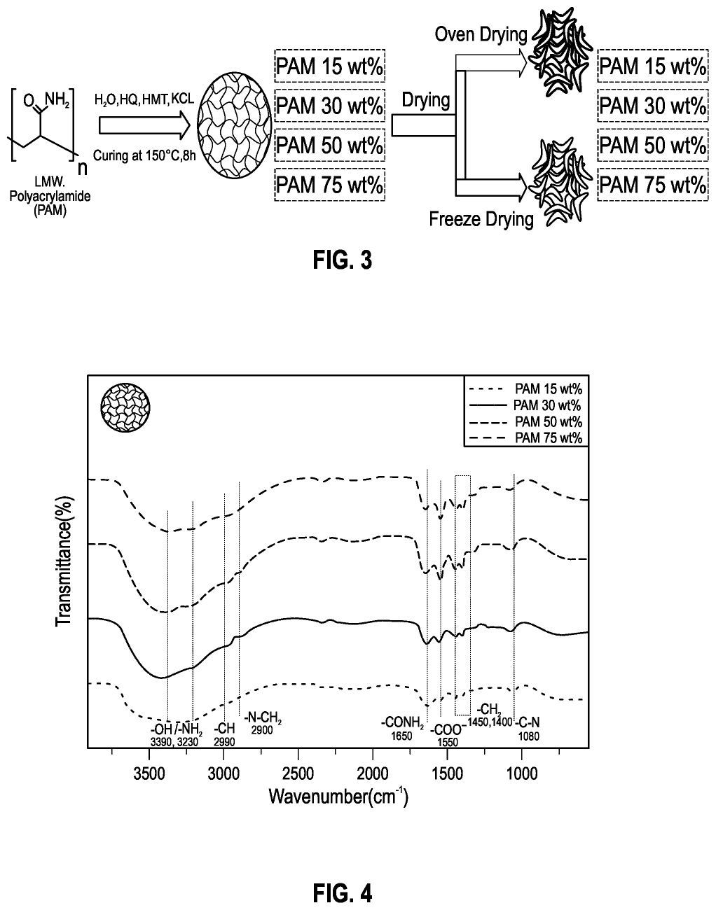

Results and Discussion: Typically, PAM aerogel with different weight ratios were prepared by the inverse emulsion polymerization method. The produced aerogels were then dried using two methods, oven-dried and freeze-dried methods to yield oven-dried aerogel and aerogel. Eventually, the aerogels were immersed in distilled water to study their swelling capacity and swelling mechanism at different temperatures (FIG. 3). The aerogels' structural properties and thermal stability were then studied using various techniques.

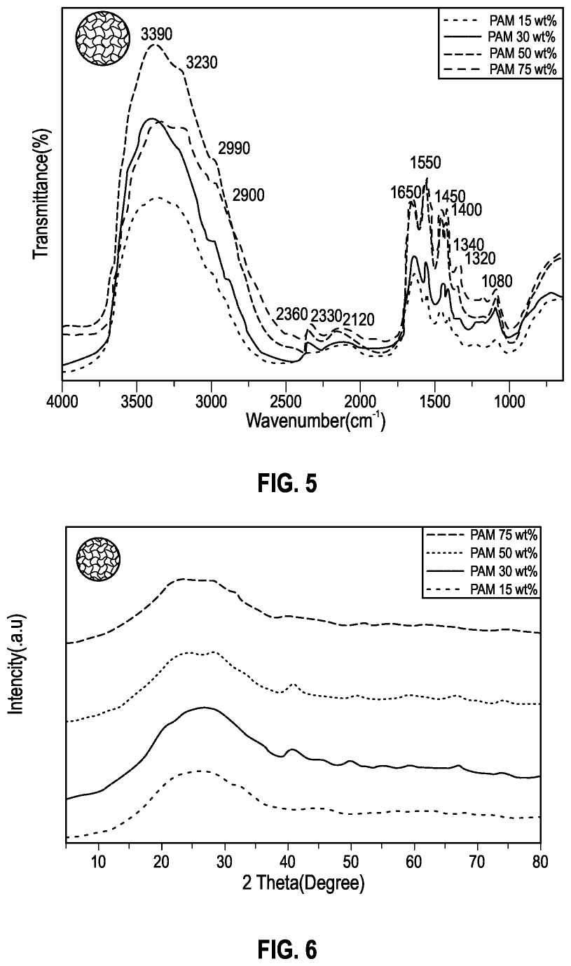

FTIR: In IR spectroscopy, the presence of different functional groups causes energy to be absorbed in certain wavelengths and re-transmitted, to form peaks. FIG. 4 and FIG. 5 shows the FTIR spectra of the PAM aerogels with different PAM ratios with all characteristic peaks. As shown, the broad transmittance bands at 3390 and 3230 cm⁻¹ were assigned to (—OH stretching, —NH₂ asymmetric stretching) and secondary amide NH₂ stretching groups. Distinctive peaks at 2990 cm⁻¹ and 2900 cm⁻¹ were ascribed to asymmetric CH₂ groups and —N—CH₂ bonds. The absorption bands at 1650 and 1550 cm⁻¹ were attributed to primary amide C═O stretching (CONH₂) and secondary amide NH bending of the acrylamide unit. The transmittance bands at 1450 and 1080 cm⁻¹ were assigned to —CH₂ and stretching vibration of C—N groups, respectively.

XRD: XRD analysis was conducted to examine the crystalline structure and phase's existent in PAM. The XRD patterns of PAM aerogels with different PAM ratios are shown in FIG. 6. All samples exhibited a broad diffraction peak around 26°, representing the amorphous nature of the polymer.

DSC: Free water and bound water have a noteworthy impact on the stability structure of the PAM aerogels. Where free water term refers to water molecules that are bound to other water molecules by a hydrogen bond. The bound water refers to water that is chemically bound to the surface. To calculate the free and bound water in the aerogel, Equations (3) and (4) are applied.

$$\begin{matrix}wf = \frac{Δ H}{Δ Ho} & Equation ( 3 ) \\ wb = 1 - wf & Equation ( 4 )\end{matrix}$$

where w_{b} is the bound water, w_{f} is the free water, ΔH is the enthalpy required for heating the free water in the aerogel, and ΔH° is the 333.5 J/g standard degradation enthalpy of free water.

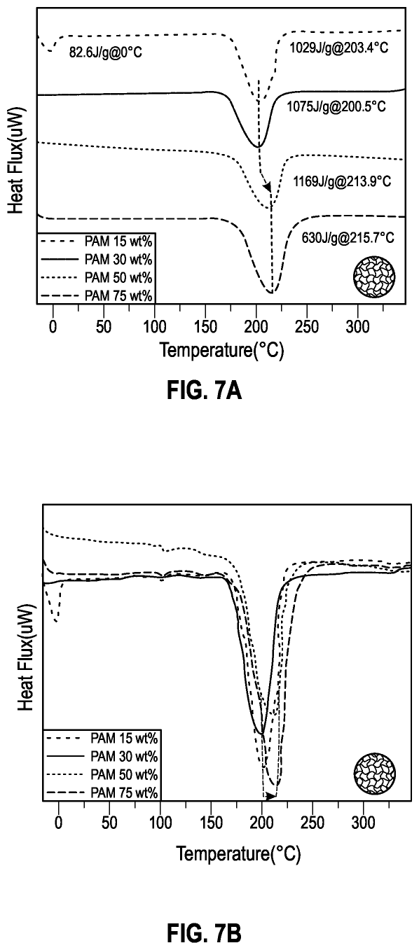

Studying the thermal stability of the aerogel requires understanding the interaction between the polymer and water molecules since the main abundant percentage of a aerogel is water. It observed that at 30, 50 and 75 wt % of PAM aerogel attained 100% bound water while at lower concentration (15 wt %), the PAM aerogel had free water, as illustrated in FIG. 7A and FIG. 7B. This suggests that a higher number of bound water are chemically bound/entrapped within the PAM matrix at higher PAM ratios. Furthermore, a remarkable rise in the degradation temperature (T_{deg}) of PAM aerogel by around 10° C. upon the increase of PAM percentage from 15 wt % up to 75 wt %. Along with increases in the degradation enthalpy (H_{deg}), which reflected the gel strength. In another word, denser networks require higher energy to degrade, due to the increase in the crosslinking densities that restricts their chain mobility movements.

TABLE 2
DSC thermograms of PAM aerogels with different PAM ratios:

| Sample | | H [symbol] | | | H_{deg} | T_{deg} |
|---|---|---|---|---|---|---|
| No. | Sample Name | (J/g) | w [symbol] | w [symbol] | (J/g) | (° C.) |
| 1 | PAM 15 wt % | 82.6 | 0.247676 | 0.752324 | 1029 | 203.4 |
| 2 | PAM 30 wt % | — | 0 | 1 | 1075 | 200.5 |
| 3 | PAM 50 wt % | — | 0 | 1 | 1169 | 213.9 |
| 4 | PAM 75 wt % | — | 0 | 1 | 630 | 215.7 |

[symbol]

indicates data missing or illegible when filed

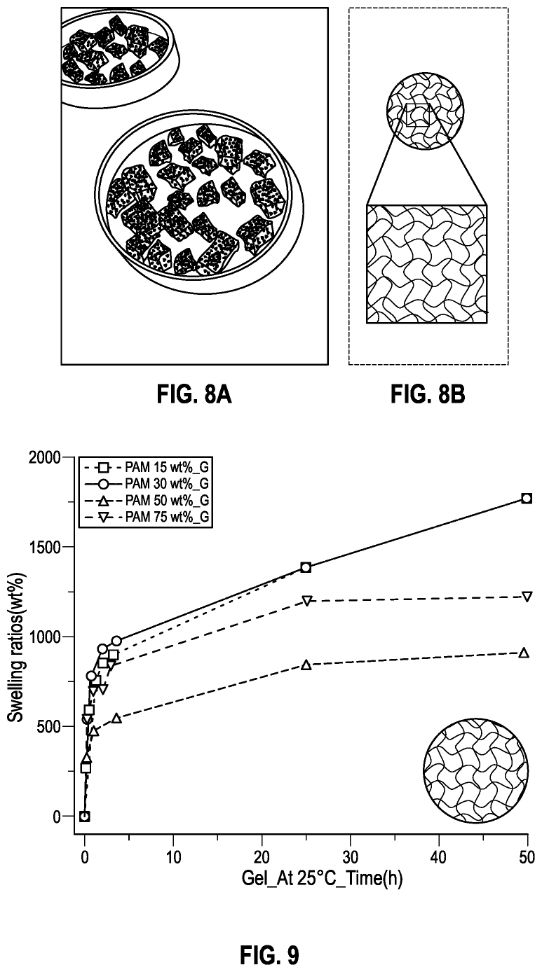

Swelling: Following physicochemical characterization, the suitability of four ratios of PAM aerogels as soil water storage were examined. The required key properties of these samples, such as water absorption, swelling behaviour, water retention and recyclability were investigated. To investigate the SR of different PAM aerogel ratios, such aerogel samples in gel form were immersed in a water solution at room temperature. And their water absorption rates were calculated by measuring the amount of water absorbed at various times. PAM aerogel samples were cut into small pieces using a clean scissor to be used later in the swelling studies (FIG. 8A and FIG. 8B). A swelling study was then conducted in distilled water at room temperature for 48 h, with 15 min intervals in the first hour, followed by one measurement every hour for 3 h. We can see clearly, from FIG. 9 that the SR of aerogels rapidly increased during the first three hours and reached 50% of their equilibrium swelling rate. Followed by a gradual increase until a plateau is reached. The maximum absorption was recorded for PAM 15 wt % and PAM 30 wt % samples with SR 1779 wt %.

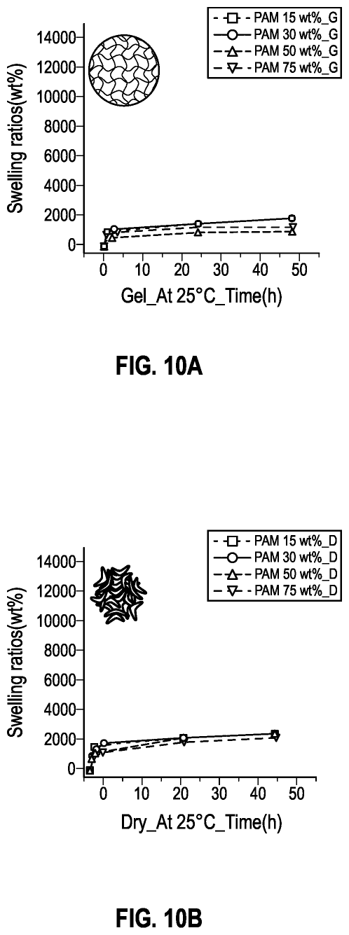

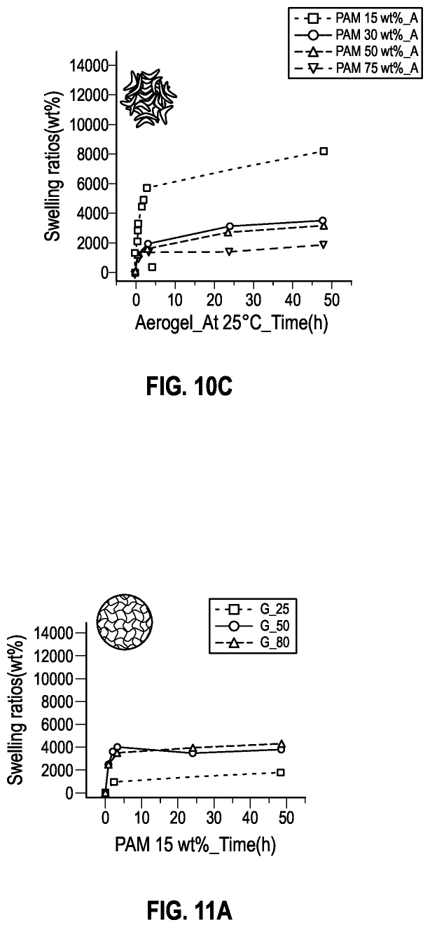

The gels were then dried using two different drying methods to explore the effect of the thermal drying method (oven drying), and non-thermal drying method (freeze drying) on the water absorption capacity. As elucidated in FIG. 10A, FIG. 10B and FIG. 10C the freeze-dried (aerogel) samples especially PAM 15 wt %, have a higher swelling ratio with a faster water absorption rate compared to gel and oven-dried samples. This is can be explained that throughout the freeze-drying process the capillary stress is avoided which prevents structural collapse and subsequently minims the shrinkage of the material. These results suggest that the freeze-drying method produces material with higher porosity, rigidity and stable structure which are a preferential path for water to penetrate. In contrast to the oven-dried samples where their structures were entirely distorted.

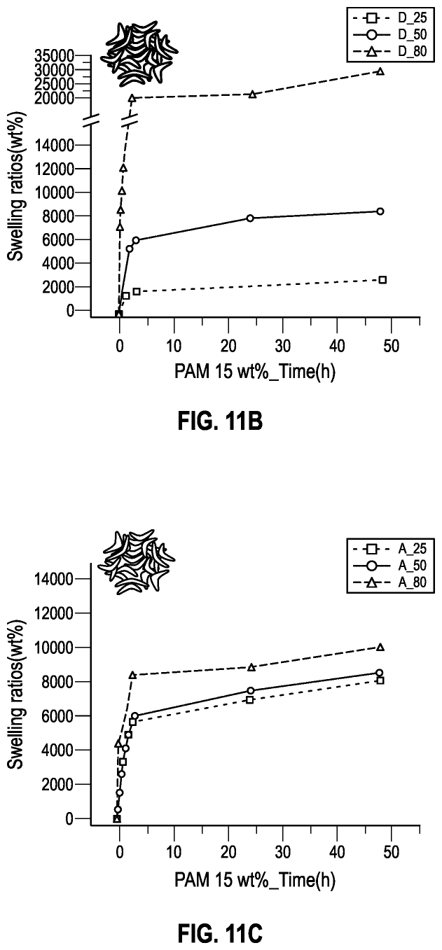

According to the drying method effect study, PAM aerogel with a 15 wt % ratio had the highest water absorption capacity with SR around 8000 wt % at room temperature in aerogel form. Therefore, we decide to focus our current study on PAM 15 wt % ratio. After that, we examine the effect of water-absorbing temperature (25° C., 50° C. and 80° C.) on the swelling ratio of PAM-15 wt % in gel (G), oven-dried (D) and aerogel (A) forms. At first glance, to FIG. 11A, FIG. 11b and FIG. 11C a direct correlation can be detected between the swelling temperature and swelling ratios. For the gel sample form, the SR increased by 60% difference at elevated temperature compared to SR at 25° C. A more noticeable temperature effect was detected for the PAM-15 wt % in oven-dried and freeze-dried sample forms. Where SR of the oven-dried (D) and aerogel (A) rises by 90% and 20%, respectively at 80° C. Commonly, elevation in temperature can prompt polymer chains expansion, which leads consequently to an increase in SR. However, the difference in SR of the oven-dried sample is higher than the freeze-dried sample, the aerogel sample had remained excellent water-absorbing capacity at room temperature. Moreover, we have noticed that at a higher temperature the freeze-dried sample has better structural stability than the oven-dried sample.

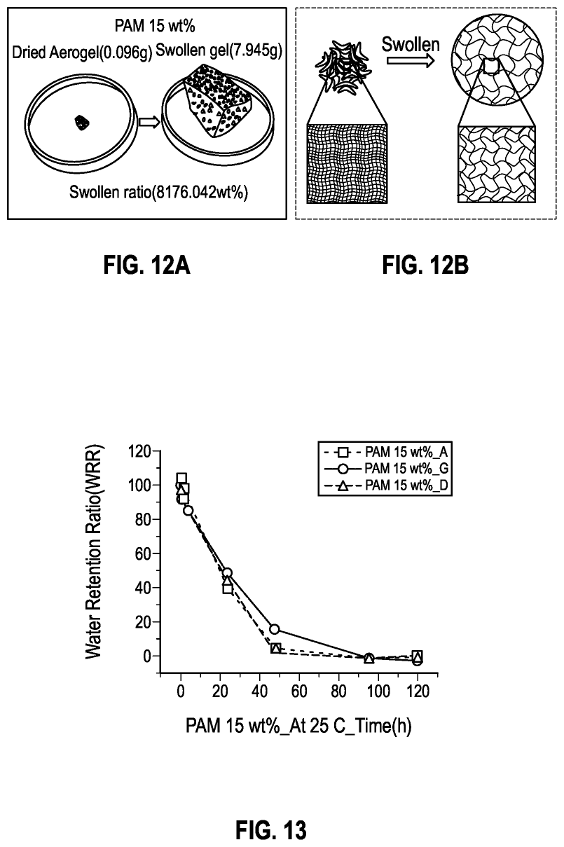

The picture in FIG. 12A and FIG. 12B shows PAM 15 wt % aerogel in aerogel form before and after swelling in pure water at 25° C. It can be observed that the weight of the swollen aerogel sample increases 83-fold higher than the dried one, after immersing it in excess distilled water to reach an equilibrium swelling SR. To the best of our knowledge, this is the highest value reported for super water-absorbent polymers so far.

Deswelling: After reaching the swollen PAM 15 wt % aerogel with different forms of their swelling equilibriums at 25° C., they reused again in the water retention experiment. The water retention capability of the swollen PAM 15 wt % samples was tested in the open air at room temperature. FIG. 13 demonstrated an extended water release of up to four days, with a water retention ratio (WRR) of around 40% after one day in the open air, indicating good water retention abilities.

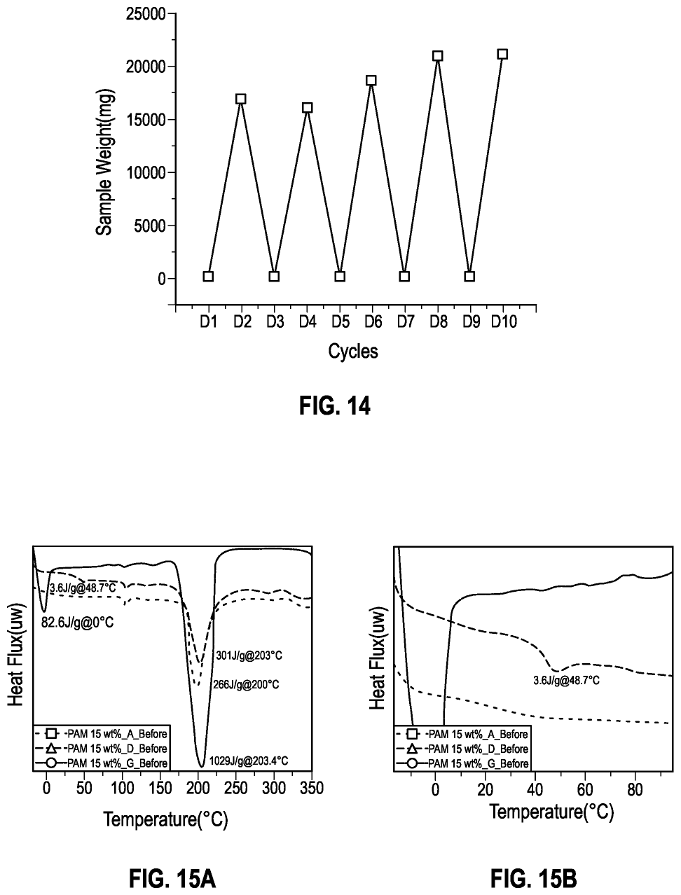

Recyclability: Experiments of sequential swelling/deswelling cycles in distilled water are performed to assess the recyclability of PAM 15 wt % in aerogel form (FIG. 14). To begin, the freeze-dried PAM 15 wt % sample is immersed in excess distilled water to achieve its' equilibrium swelling. Following that, the swollen aerogel sample will be removed from the water and dried to a constant weight at 50 C. The dried sample is then weighted and immersed again in water. This swelling/drying cycle is repeated ten times. After 10 cycles, SR is still high, indicating that this SAH sample has an excellent reswelling capability. This recyclability ability can be ascribed to its well-interconnected structures with a strong framework.

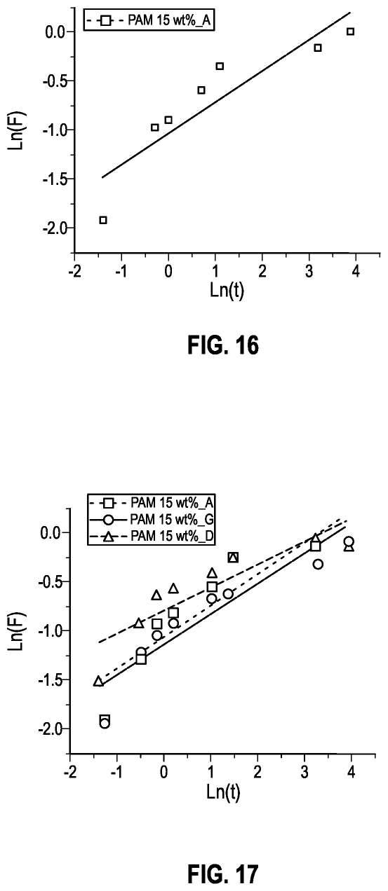

Mechanism: To evaluate the effect of the drying process on the aerogel network from a thermodynamic perspective the DSC was recorded, and their corresponding aspects were calculated. In FIG. 15A and FIG. 15B, the DSC curve of the oven-dried sample exhibit appearance of a distinct endothermic peak at around 50° C. with an enthalpy value ΔH=3.6 J/g. This distinct peak suggests that the drying process alters the gel structure differently, which might suggest structural collapse. To determine the disorder stability, the entropy ΔS was calculated as ΔH/T as shown in the table below FIG. 16 and FIG. 17. The entropy value indicates that the aerogel after oven-dried was less ordered, this is probably because of the drying temperature, compared to the aerogel before drying. Thus, demonstrating that the freeze-drying method produces a more stable structure than the oven-dried method.

TABLE 3
DSC thermograms of PAM 15 wt % aerogels
at different drying methods:

| | H_{deg} (J/g) | T_{deg} (° C.) |
|---|---|---|
| PAM 15 wt %_Hydrogel (G) | 1029 | 203.4 |
| PAM 15 wt %_Oven-dried (D) | 301 | 203.0 |
| PAM 15 wt %_Freeze-dried (A) | 266 | 200.0 |

| | | | Freeze-dried |
|---|---|---|---|
| | Hydrogel (G) | Oven-dried (D) | (A) |
| Temperature (° C.) | — | 48.7 | — |
| ΔH (J/g) | — | 3.6 | — |
| ΔS* (J/g⁻¹° C.⁻¹) | — | 0.07 | — |

Swelling Kinetics: Understating the kinetics mechanism of the swelling process is a very crucial role in aerogel technology. Typically, swelling of a aerogel consists of water

$$\begin{matrix}Ln ( F ) = nLn ( t ) + Ln ( k ) & Equation ( 5 ) \\ F = \frac{{S}_{t}}{{S}_{eq}} & Equation ( 6 ) \\ SR = \frac{Dried weight - Swollen wieght}{Dried weight} & Equation ( 7 )\end{matrix}$$

penetration into the aerogel voids and eventually expands the polymeric chains. Numerous techniques had reported in the literature to study the swelling mechanism and among them, a simple Fickian diffusion model is applied as expressed in Equations (5-7):

Where F symbolizes the water fraction at time t; Sₜ and S_{eq} denote SR at time t (h) and equilibrium SR, respectively; t is the swelling time; K refers to the swelling rate constant, and n is the diffusional/swelling exponent, which indicates the water transport mechanism. The constants n and k are calculated from the slopes and intercepts of the graph of ln(F) against ln(t) for PAM 15 wt % aerogel in distilled water at 25° C. Four diffusion mechanism types are identified based on n values. For the first one, n≤0.5 the diffusion mechanism is a Fickian diffusion, where a simple concentration gradient is responsible for water transport; for the second one, 0.5<n<1.0, corresponds to non-Fickian diffusion or anomalous diffusion, where the diffusion and relaxation are both isochronally effective; and the third one when n=1.0, the diffusion is designated as Case II diffusion, where the diffusion is very fast, contrary to the rate of relaxation. The fourth one is when n>1.0, which rarely happens, and is assigned to the super Case II diffusion mechanism.

TABLE 4
The curves of Ln(t) versus Ln(F) of PAM 15 wt % aerogels
at different drying methods in deionized water at 25° C.:

| Sample Name | Initial Regression Equation | R² | n | In(k) |
|---|---|---|---|---|
| PAM 15 wt %_Freeze-dried (A) | Ln(F) = (0.32038)In(t) + (−1.04476) | 0.81147 | 0.32038 | −1.04476 |
| Sample Name | Initial Regression Equation | R2 | n | In(k) |
| PAM 15 wt %_Hydrogel (G) | Ln(F) = (0.32038)In(t) + (−1.04476) | 0.81147 | 0.32038 | −1.04476 |
| PAM 15 wt %_Oven-dried (D) | Ln(F) = (0.30912)In(t) + (−1.11262) | 0.87848 | 0.30912 | −1.11262 |
| PAM 15 wt %_Freeze-dried (A) | Ln(F) = (0.23511)In(t) + (−0.77572) | 0.81344 | 0.23511 | −0.77572 |

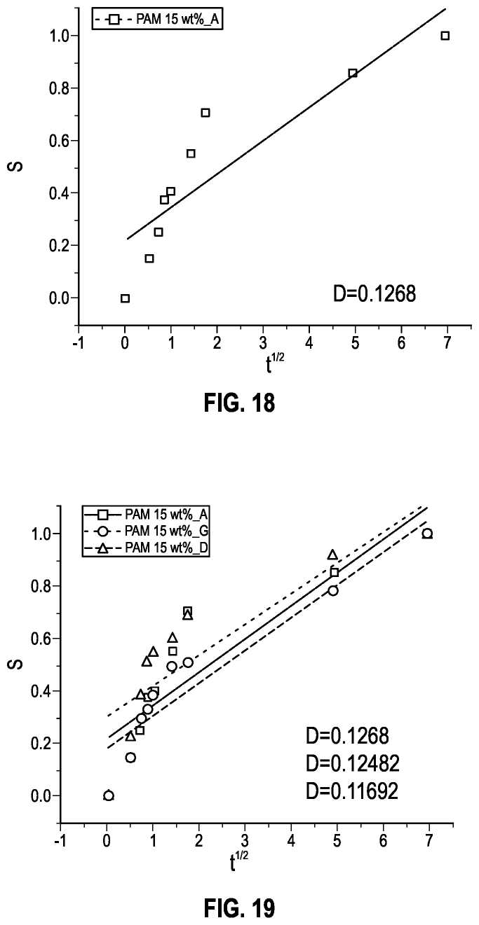

In order to decide which diffusion mechanism mode our samples obey, Ln(t) versus Ln (F) was plotted and the slope of the obtained straight lines gives the swelling exponent value n. As seen in FIG. 18, the curve of Ln(t) versus Ln(F) showed a linear fit with a linear correlation coefficient (R²=0.81). According to FIG. 19 results, the swelling kinetics behaviours of PAM 15 wt % aerogel follow a Fickian-mode diffusion mechanism, where n≤0.5, such mode is very suitable for controlled release applications.

What is claimed is:

1. A method of making a polymer aerogel, comprising:
mixing a low molecular weight polymer with a deionized water to make a mixture;
stirring the mixture to dissolve at room temperature to make a solution;
adding a known amount of hydroquinone, hexamethylenetetramine and KCl salt to the solution to make a mixed solution; and
placing the mixed solution in a hydrothermal vessel inside an oven for 8 hours and 150° C. to make the polymer aerogel.

2. The method of claim 1, wherein the low molecular weight polymer is a polyacrylamide.

3. The method of claim 2, wherein the polyacrylamide is used in different ratios at 15%, 30% and 75%.

4. The method of claim 1, further comprising;
immersing the polymer aerogel containing different ratio of a polyacrylamide in water to measure a water absorption, swelling ratio, water retention and recyclability.

5. The method of claim 4, wherein the swelling ratio was calculated using equation 1.

6. The method of claim 4, wherein the water retention ratio was calculated using equation 2.

7. The method of claim 4, wherein the best swelling ratio was found in polymer aerogel containing 15% polyacrylamide in polymer aerogel was observed.

8. A method of making a polymer aerogel, comprising:
mixing a low molecular weight polymer with a deionized water to make a mixture;
stirring the mixture to dissolve at room temperature to make a solution;
adding a known amount of hydroquinone, hexamethylenetetramine and KCl salt to the solution to make a mixed solution;
placing the mixed solution in a hydrothermal vessel inside an oven for 8 hours and 150° C. to make the polymer aerogel;
immersing the polymer aerogel containing different ratio of a polyacrylamide in water to measure a water absorption, swelling ratio, water retention and recyclability; and
using the polymer aerogel to irrigate agricultural land.

9. The method of claim 8, wherein the low molecular weight polymer is a polyacrylamide.

10. The method of claim 9, wherein the polyacrylamide is used in different ratios at 15%, 30% and 75%.

11. The method of claim 8, wherein the swelling ratio was calculated using equation 1.

12. The method of claim 8, wherein the water retention ratio was calculated using equation 2.

13. The method of claim 10, wherein the best swelling ratio was found in polymer aerogel containing 15% polyacrylamide in polymer aerogel was observed.

14. A method of making a polymer aerogel, comprising:
mixing a low molecular weight polymer with a deionized water to make a mixture, wherein the low molecular weight polymer is a polyacrylamide, wherein the polyacrylamide is used in different ratios at 15%, 30% and 75%;
stirring the mixture to dissolve at room temperature to make a solution;
adding a known amount of hydroquinone, hexamethylenetetramine and KCl salt to the solution to make a mixed solution;
placing the mixed solution in a hydrothermal vessel inside an oven for 8 hours and 150° C. to make the polymer aerogel;
immersing the polymer aerogel containing 15% ratio of a polyacrylamide in water to measure a water absorption, swelling ratio, water retention and recyclability; and
using the polymer aerogel to irrigate agricultural land.
